(19) United States
(12) Patent Application Publication
(10) Pub. No.: US 2026/0303878 A1
(43) Pub. Date: Oct. 1, 2026

(54) TECHNIQUES FOR IMPROVED DEBLOCKING FILTERING

(71) Applicant: NETFLIX, INC., Los Gatos, CA (US)

(72) Inventor: Andrey NORKIN, Campbell, CA (US)

(21) Appl. No.: 19/372,021

(22) Filed: Oct. 28, 2025

Related U.S. Application Data
(60) Provisional application No. 63/781,013, filed on Mar. 31, 2025.

(51) Int. Cl. H04N 19/86; H04N 19/117; H04N 19/132; H04N 19/80

(52) U.S. Cl. CPC H04N 19/86; H04N 19/117; H04N 19/132; H04N 19/80

(57) ABSTRACT

Techniques for improved deblocking filtering are disclosed. The techniques include receiving a first block and a second block of a first image; performing, based on sample values on one or more sides of a block boundary between the first block and the second block, one or more evaluations relative to one or more thresholds; determining, based on the one or more evaluations, a first number of samples to modify on a first side of the block boundary, wherein the first number is different from a second number of samples to modify on a second side of the block boundary; and performing, based on the first number of samples and the second number of samples, asymmetrical deblocking filtering on the first image to generate a second image.

### CROSS-REFERENCE TO RELATED APPLICATIONS

This application claims priority benefit of the U.S. Provisional Patent Application titled, “TECHNIQUES FOR IMPROVED DEBLOCKING FILTERING,” filed on Mar. 31, 2025, and having Ser. No. 63/781,013. The subject matter of this related application is hereby incorporated herein by reference.

### BACKGROUND

### Technical Field

The embodiments of the present disclosure relate generally to computer science, streaming, and video processing technologies, and more specifically, to techniques for improved deblocking filtering.

### Description of the Related Art

A deblocking filter is a video processing technique that smooths out sharp grid-like artifacts (referred to as “blocking artifacts”) that appear at the boundaries of pixel blocks in compressed video, improving the visual quality of a decoded video. Video codecs for compression and decompressing video files typically operate on rectangular blocks. The blocks are standardized, grid-like sections of pixels that video frames are divided into for compression. However, compression can cause the signal representation of each block at lower bitrates to deviate from the underlying signal of the original block. As operations of the video codec, including transform and quantization, are applied independently in each block, visually noticeable block artifacts can be created at block boundaries between the neighboring blocks. Deblocking filtering is designed to mitigate block artifacts, for example, at block boundaries.

Conventional deblocking filters typically use information sent in a video bitstream, including, for example, location of the transform and prediction block boundaries, block sizes, and quantization parameters. The deblocking filter determines picture locations where discontinuities may appear. Then, the deblocking filtering evaluates the signal at the sides of the block boundary to determine the strength of the filtering to be applied and whether the filtering should be applied at all. Typically, stronger filtering is applied when the signal is smooth on both sides of a block boundary, which indicates that a discontinuity is likely caused by compression and may also be more visible in the area.

One drawback of conventional deblocking filtering is that a block boundary must have the same number of samples (e.g., luma samples) on each side of a block boundary between two blocks or areas within a region such as a superblock that represents a largest and most fundamental block a video frame is divided into for processing, a tile that represents an independently encoded region of a video frame, or a coding tree unit that represents the largest processing blocks used to compress video data. As a result, deblocking operations are constrained when samples are unavailable, for example, at superblock, tile, or coding tree unit boundaries. The symmetrical sample requirement prevents deblocking from occurring at certain locations in a frame or image, resulting in artifacts near superblock, tile, or coding tree unit edges.

Another drawback of conventional deblocking filtering is that these approaches oftentimes use a static number of samples on each side of a block boundary. In addition to the number of samples being symmetrical, the number of samples is often statically determined. However, different numbers of samples on each side of a block boundary cause differing deblocking outcomes such that selecting a single number of samples for all deblocking filtering operations represents a tradeoff in quality. A further drawback of conventional deblocking filtering is that each line is considered separately, causing additional artifacts.

As the foregoing illustrates, what is needed in the art are more effective techniques for deblocking filtering.

### SUMMARY

One embodiment of the present disclosure sets forth a computer-implemented method for deblocking filtering. The method includes receiving a first block and a second block of a first image; performing, based on sample values on one or more sides of a block boundary between the first block and the second block, one or more evaluations relative to one or more thresholds, where the sample values include values for two or more of a plurality of lines of the first image; determining, based on the one or more evaluations, a first number of samples to modify on a first side of the block boundary, where the first number is different from a second number of samples to modify on a second side of the block boundary; and performing, based on the first number of samples and the second number of samples, asymmetrical deblocking filtering on the first image to generate a second image.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques enable deblocking operations in scenarios where samples are unavailable, for example, based on coding tree unit boundaries and/or tile boundaries. An additional technical advantage of the disclosed techniques is that the number of samples on each side of a block boundary is determined independently, enabling asymmetrical numbers of samples on each side of the block boundary. Another technical advantage of the disclosed techniques is that the number of samples on each side of a block boundary is dynamically determined multiple times per image to optimize deblocking performance in multiple regions of the image. A further technical advantage is multiple different lines (or columns) can be used to determine the number of samples on each side of a block boundary. Accordingly, the disclosed techniques can improve the quality of decoded video frames, including reducing or eliminating artifacts therein, relative to conventional deblocking filtering. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments of the present disclosure.

FIG. 2 is a block diagram of a content server that can be implemented in conjunction with the network infrastructure of FIG. 1, according to various embodiments of the present disclosure.

FIG. 3 is a block diagram of a control server that can be implemented in conjunction with the network infrastructure of FIG. 1, according to various embodiments of the present disclosure.

FIG. 4 is a block diagram of an endpoint device that can be implemented in conjunction with the network infrastructure of FIG. 1, according to various embodiments of the present disclosure.

FIG. 5 is more detailed illustration of the playback application of FIG. 4, according to various embodiments.

FIG. 6 illustrates an example of deblocking image data to generate modified image data relative to a block boundary, according to various embodiments.

FIG. 7 sets forth a flow diagram of method steps for generating asymmetrical filter lengths relative to a block boundary, according to various embodiments.

FIG. 8 sets forth a flow diagram of method steps for deblocking filtering, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

As described, one drawback of conventional deblocking filtering is that a block boundary must have the same number of samples on each side of a block boundary between two blocks within a larger region such as a superblock, a tile, or a coding tree. As a result, deblocking operations are constrained when samples are unavailable, for example, at superblock, tile, or coding tree unit boundaries. The symmetrical sample requirement prevents deblocking from occurring at certain locations in a frame or image, resulting in artifacts near superblock, tile, or coding tree unit edges. Another drawback of conventional deblocking filtering is that these approaches oftentimes use a static number of samples on each side of a block boundary. In addition to the number of samples being symmetrical, the number of samples is often statically determined. However, different numbers of samples on each side of a block boundary cause differing deblocking outcomes such that selecting a single number of samples for all deblocking filtering operations represents a tradeoff in quality. A further drawback of conventional deblocking filtering is that each line is considered separately, causing additional artifacts.

The disclosed techniques improve deblocking filtering quality. By contrast with existing techniques, the disclosed techniques advantageously provide for asymmetrical deblocking operations, dynamically determining a filter size multiple times along a block boundary, and using multiple different lines and/or columns to determine the number of samples on each side of a block boundary to use for deblocking filtering. These technical improvements can reduce or eliminate artifacts, relative to conventional deblocking filtering.

In some embodiments, a deblocking filter module of a playback application receives a first block and a second block of a first image. The deblocking filter module performs, based on sample values on one or more sides of a block boundary between the first block and the second block, one or more evaluations of inequalities relative to one or more thresholds, where the sample values include values for two or more of a plurality of lines of the first image. The deblocking filter module determines, based on the one or more evaluations, a first number of samples to modify on a first side of a block boundary between the first block and the second block, where the first number is different from a second number of samples to modify on a second side of the block boundary. In addition, the deblocking filter module performs, based on the first number of samples and the second number of samples, asymmetrical deblocking filtering on the first image to generate a second image.

Advantageously, the disclosed techniques enable deblocking operations in scenarios where samples are unavailable, for example, based on coding tree unit boundaries and/or tile boundaries. An additional technical advantage of the disclosed techniques is that the number of samples on each side of a block boundary is determined independently, enabling asymmetrical numbers of samples on each side of the block boundary. Another technical advantage of the disclosed techniques is that the number of samples on each side of a block boundary is dynamically determined multiple times per image to optimize deblocking performance in multiple regions of the image. A further technical advantage is multiple different lines (or columns) can be used to determine the number of samples on each side of a block boundary. Accordingly, the disclosed techniques can improve the quality of decoded video frames, including reducing or eliminating artifacts therein, relative to conventional deblocking filtering.

### System Overview

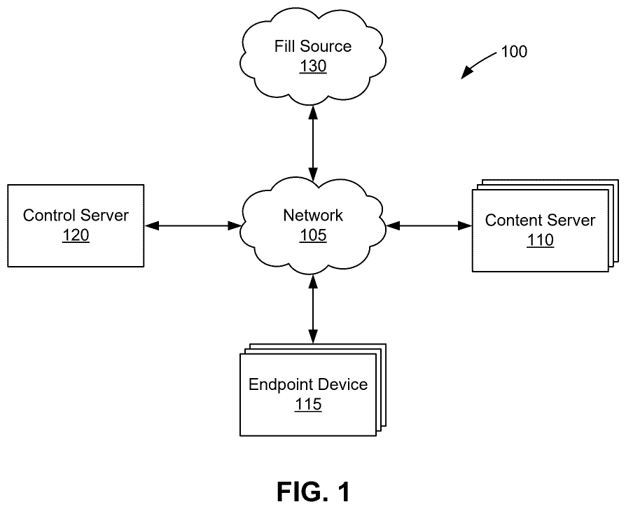

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content servers 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond fill source 130 to the extent desired or necessary.

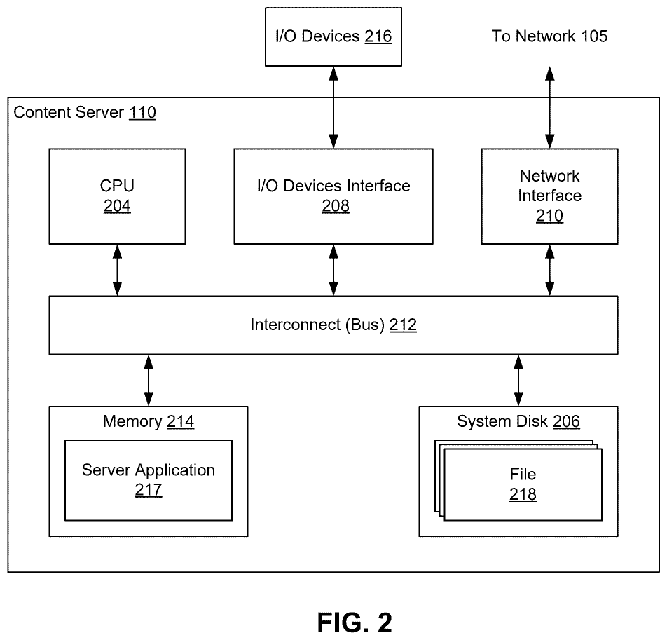

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

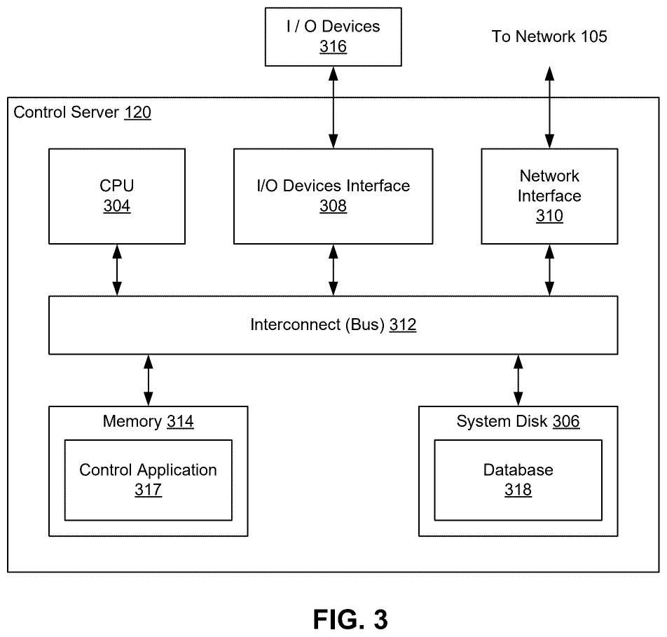

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

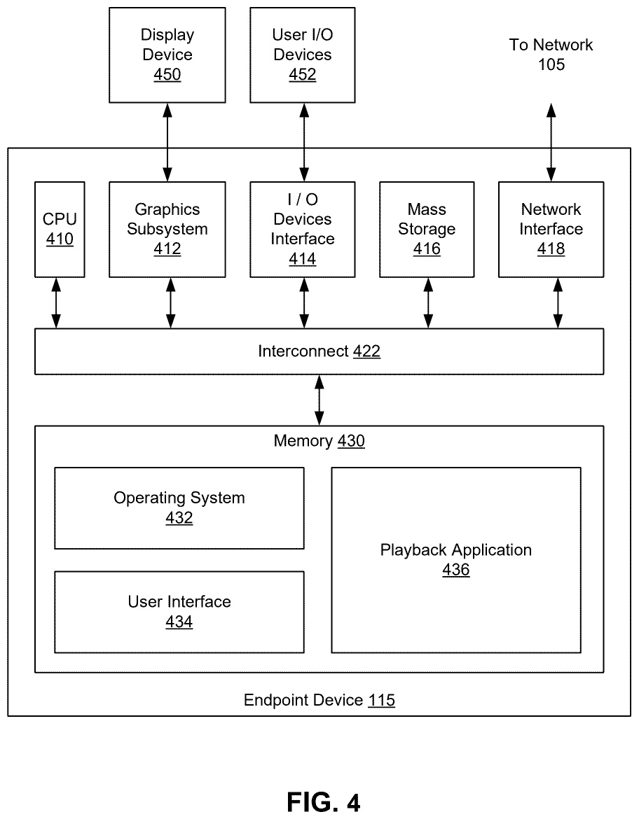

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory 430.

In some embodiments, the CPU 410 is configured to retrieve and execute programming instructions stored in the memory 430. Similarly, the CPU 410 is configured to store and retrieve application data (e.g., software libraries) residing in the memory 430. The interconnect 422 is configured to facilitate transmission of data, such as programming instructions and application data, between the CPU 410, graphics subsystem 412, I/O devices interface 414, mass storage 416, network interface 418, and memory 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 105 via the network interface 418. Further, the playback application 436 is configured to interpret the content and present the content via display device 450 and/or user I/O devices 452.

### Deblocking Filtering System

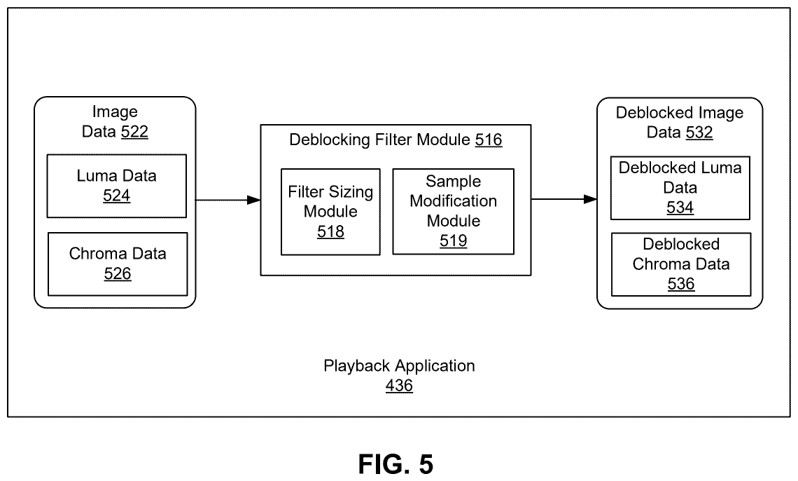

FIG. 5 is a more detailed illustration of the playback application 436 of FIG. 4, according to various embodiments. As shown, the playback application 436 includes, without limitation, a deblocking filter module 516. The deblocking filter module 516 includes, without limitation, a filter sizing module 518 and a sample modification module 519. In operation, the deblocking filter module 516 processes image data 522 and generates deblocked image data 532. The image data 522 includes, without limitation, luma data 524 and chroma data 526. The deblocked image data 532 includes, without limitation, deblocked luma data 534 and deblocked chroma data 536.

In operation, the playback application 436 is configured to request and receive media such as encoded images, videos, and/or the like from one or more of the content servers 110. The playback application 436 decodes the received content and presents the decoded content via a display device (e.g., display device 450) and/or user I/O devices. The deblocking filter module 516 is a module of the playback application 436 that performs deblocking filtering as part of the decoding process. In some embodiments, the image data 522 processed by the deblocking filter module 516 can include image data used by or generated during the decoding process.

In some embodiments, the deblocking filter module 516 performs deblocking filtering that provides beneficial modifications over other deblocking processes such as AOMedia Video Model (AVM) deblocking. In various embodiments, the deblocking filter module 516 applies a configurable luma sample limit and a configurable chroma sample limit, determines deblocking filtering decisions for a four sample (e.g., four line) boundary based on two of the four lines of samples, and/or uses asymmetric filtering on the horizontal superblock boundary to improve the visual quality of the deblocking filtering. The deblocking filter module 516 attenuates some artifacts related to filtering relative to region boundaries such as a coding tree unit boundary, tile boundary, super block boundary and/or the like. In some examples, the deblocking filter module 516 reduces high frequency artifacts relative to conventional deblocking techniques.

The deblocking filter module 516 retrieves or receives image data 522, deblocks the image data 522 to generate deblocked image data 532, and stores or transmits the deblocked image data 532 for use and/or storage. The deblocking filter module 516 is shown including the filter sizing module 518 and the sample modification module 519.

The filter sizing module 518 makes sample-based deblocking filtering decisions based on samples of the image data 522. In some embodiments, the filter sizing module 518 determines a maximum length of filtering using block-based logic, and one or more filter lengths of a configurable filter are determined based on the sample values relative to the block boundary. The filter sizing module 518 determines a configurable filter for deblocking filtering. The filter sizing module 518 determines the configurable filter including a first filter size for a first side of a block boundary and a second filter size for a second side of the block boundary. The filter sizing module 518 determines the first filter size for the first side of a block boundary independently from the second filter size for the second side of the block boundary. As a result, the configurable filter can be symmetric or asymmetric based on sample values of the image data 522.

In some embodiments, a maximum number of samples for the filter is a configurable value, and the filter sizing module 518 determines a symmetric filter for samples of image data 522 that is greater than the maximum number of samples away from a region boundary such as a coding tree unit boundary, tile boundary, super block boundary and/or the like. The filter sizing module 518 independently determines a potentially asymmetric filter for samples of image data 522 within the maximum number of samples from the region boundary. In some embodiments, the filter sizing module 518 determines a symmetric filter for samples of image data 522 up to a threshold number of samples from a block boundary, and then determines an asymmetric filter for samples of image data 522 greater than the threshold number of samples. In some cases the threshold number of samples is based on a number of available samples on one side of the block boundary, such as number of available samples between the block boundary and a region boundary and/or the like.

In some embodiments, the filter sizing module 518 determines a configurable luma filter based on samples of the luma data 524 and separately or independently determines a configurable chroma filter based on samples of the chroma data 526. In some examples, a maximum number of samples on each side of the block boundary is eight samples for the luma component (e.g., luma data 524), and two samples for the chroma component (e.g., chroma data 526). However, the maximum number of samples can be any value for each of the luma data 524 and the chroma data 526. Each of the luma filter and chroma filter can be symmetric or asymmetric. In some embodiments, the filter sizing module 518 analyzes each line separately based on the sample values in the single line. In some embodiments, the filter sizing module 518 determines filter lengths of a configurable filter using multiple different lines based on sample values in two or more lines.

The sample modification module 519 performs deblocking filtering by modifying samples of the image data 522 based on the configurable filter or filters. The sample modification module 519 performs deblocking filtering by an iterative process that modifies each sample for a number of iterations corresponding to the filter lengths. As a result, the sample modification module 519 iteratively performs symmetrical and/or asymmetrical deblocking filtering based on the filter lengths on each side of the block boundary, and/or based on the region boundaries.

Once deblocking filtering by the deblocking filter module 516 and other decoding operations are completed, the playback application 436 can cause the decoded image data (e.g., a decoded video frame) to be displayed via, for example, the display device 450.

### Deblocking Example

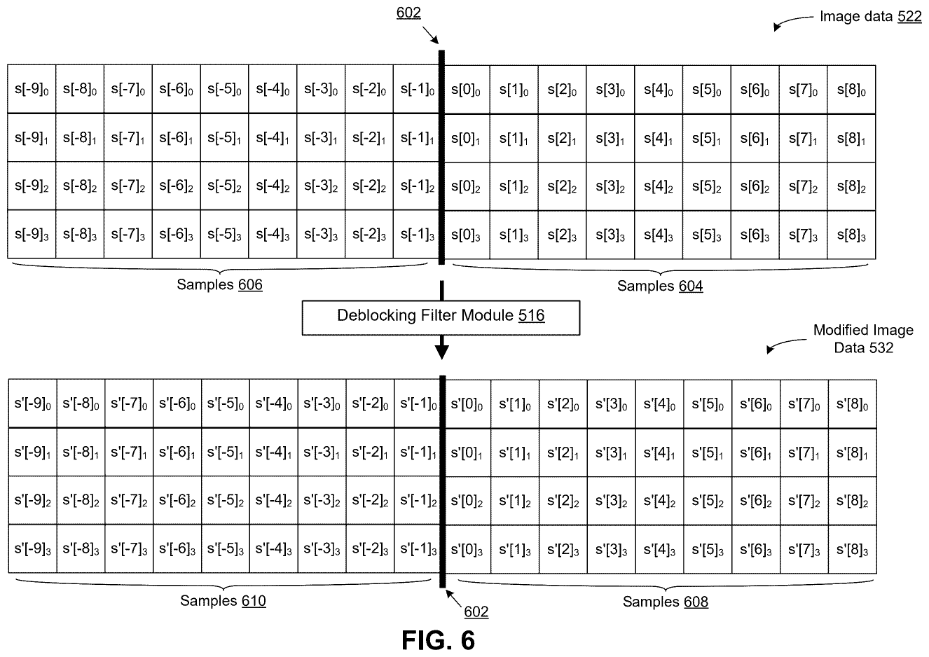

FIG. 6 illustrates an example of deblocking image data to generate modified image data relative to a block boundary, according to various embodiments. As shown, the illustration includes, without limitation, the deblocking filter module 516, the image data 522, the modified image data 532, and a boundary 602. The image data 522 includes, without limitation, samples 604 and samples 606. The image data 532 includes, without limitation, samples 608 and samples 610. Generally, the figure shows an example of how the deblocking filter module 516 deblocks image data 522 to generate the deblocked image data 532.

The image data 522 corresponds to any type of image, such as a still image, a frame of a video or animated image, and/or the like. As described, the image data 522 can include image data used by or generated during a decoding process in which encoded image data (e.g., encoded video frames) received from a content server 110 is decoded by the playback application 436. In the example shown, the image data 522 includes samples 604 on a first side of a boundary 602 and samples 606 on a second side of a boundary 602. In some embodiments, the boundary 602 is a block boundary or another boundary between samples of image data 522. Each sample includes a corresponding value or number that is used for filtering decision. All samples of the unmodified image data 522 are denoted using the letter s, a bracketed number that indicate a column, and a subscript that indicates a line.

In the illustrative example shown, the samples 604 include, without limitation, four lines and nine columns. The samples 604 can include any number of lines and columns. The four lines are denoted using subscripts including 0, 1, 2, and 3. The nine columns are denoted using negative numbers within the brackets including [0], [1], [2], [3], and so on. The column numbers provide an indication of a distance from the boundary 602. In the example shown, the column numbers to the right of the boundary 602 start with [0] and proceed into positive numbers. The samples 606 include, without limitation, four lines and nine columns. The samples 606 can include any number of lines and columns. The four lines are denoted using subscripts including 0, 1, 2, and 3. The nine columns are denoted using negative numbers within the brackets including [−1], [−2], [−3], [−4], and so on. The column numbers provide an indication of a distance from the boundary 602. In the example shown, the column numbers to the left of the boundary 602 are negative, and the numbers start with [−1] and proceed into negative numbers.

The modified image data 532 corresponds to a deblocked version of the image data 522. The image data 532 includes the samples 608 on a first side of a block boundary and the samples 610 on a second side of a boundary 602. All samples of the modified image data 532 are denoted using the letter s′, a bracketed number that indicate a column, and a subscript that indicates a line. In the illustrative example shown, the samples 608 include, without limitation, four lines and nine columns. The samples 608 can include any number of lines and columns. The samples 610 include, without limitation, four lines and nine columns. The samples 610 can include any number of lines and columns. Lines and columns are indicated in a manner similar to that described with respect to the image data 522.

The deblocking filter module 516 makes sample-based deblocking filtering decisions based on samples of the image data 522 (e.g., using the filter sizing module 518 shown in FIG. 1). The deblocking filter module 516 performs a joint filtering decision based on multiple lines of the image data 522. In this example, the first line (e.g., line denoted “0”) and the fourth/final line (e.g., line denoted “3”) are used. Specifically, the deblocking filtering decisions include an evaluation of an absolute value of a second derivative of the first line according to equation (1), and an absolute value of a second derivative of the fourth line according to equation (2).

$$d {2 [ i ]}_{0} = abs ( {s [ i + 1 ]}_{0} - 2 * {s [ i ]}_{0} + {s [ i + 1 ]}_{0} ) \qquad ( 1 )$$

$$d {2 [ i ]}_{3} = abs ( {s [ i + 1 ]}_{3} - 2 * {s [ i ]}_{3} + {s [ i + 1 ]}_{3} ) \qquad ( 2 )$$

In equations (1) and (2), the letter i indicates a column. Based on the resulting values for equations (1) and (2), the deblocking filter module 516 evaluates one or more expressions and compares the expressions to corresponding thresholds. Each of the inequalities (3)-(8) includes an expression that is evaluated to determine whether the expression is greater than a corresponding threshold. In the examples shown, each of the expressions averages sample values from multiple (e.g., two in the example shown) lines of the image data 522. In this example, the deblocking filter module 516 uses lines 0 and 3 for the average. In various embodiments, any number of lines can be used to generate a joint filtering decision.

For modification of N samples from the boundary 602, where N is less than or equal to 3, the following comparisons or inequalities should be false (e.g., not true).

$$d {2 [ i ]}_{0} + d {2 [ i ]}_{3} > thr 1 for i = 1 , - 2 \qquad ( 3 )$$

For N=2 and 3, the additional inequality is resolved.

$$d {2 [ 0 ]}_{0} + d {2 [ - 1 ]}_{0} + d {2 [ 0 ]}_{3} + d {2 [ - 1 ]}_{3} > thr 2 \qquad ( 4 )$$

For N=3, the additional inequalities are resolved.

$$abs ( {s [ - 1 ]}_{0} - {s [ - 4 ]}_{0} ) - 3 * ( {s [ - 1 ]}_{0} - {s [ - 2 ]}_{0} ) + {s [ - 1 ]}_{3} - {s [ - 4 ]}_{3} ) - 3 * ( {s [ - 1 ]}_{3} - {s [ - 2 ]}_{3} ) ) > thr 6 \qquad ( 5 )$$

$$abs ( {s [ 0 ]}_{0} - {s [ 3 ]}_{0} ) - 3 * ( {s [ 0 ]}_{0} - {s [ 1 ]}_{0} ) + {s [ 0 ]}_{3} - {s [ 3 ]}_{3} ) - 3 * ( {s [ 0 ]}_{3} - {s [ 1 ]}_{3} ) ) > thr 6 \qquad ( 6 )$$

In some embodiments, the value of threshold 2 (e.g., thr2) varies depending on the N or number of samples from the boundary 602 to be modified.

For N greater than or equal to 4, the additional inequalities are resolved.

$$abs ( {s [ 0 ]}_{0} - {s [ N ]}_{0} ) - N * ( {s [ 0 ]}_{0} - {s [ 1 ]}_{0} ) ) + abs ( {s [ 0 ]}_{3} - {s [ N ]}_{3} ) - N * ( {s [ 0 ]}_{3} - {s [ 1 ]}_{3} ) ) > thr 4 \qquad ( 7 )$$

$$abs ( {s [ - 1 ]}_{0} - {s [ - N - 1 ]}_{0} ) - N * ( {s [ - 1 ]}_{0} - {s [ - 2 ]}_{0} ) ) + abs ( {s [ - 1 ]}_{3} - {s [ - N - 1 ]}_{3} ) - N * ( {s [ - 1 ]}_{3} - {s [ - 2 ]}_{3} ) ) > thr 4 \qquad ( 8 )$$

The deblocking filter module 516 evaluates each of the expressions to determine a filter length N. If the inequalities are true (e.g., if the values on the left exceed the corresponding thresholds), then the prior N value is used. As a result, the number of samples N is the largest N for which all inequalities are false, such that the calculated values do not exceed the specified threshold. In some embodiments, deblocking filter module 516 determines thresholds thr1 and thr4 based on an evaluation of signal smoothness on each side of the boundary 602 and further based on a dependent side threshold.

The deblocking filter module 516 generates deblocked image data 532 based on image data 522 (e.g., using the sample modification module 519 shown in FIG. 1). In some embodiments, the deblocking filter module 516 uses a clipping or clamping threshold thr5 to clamp delta (or delta′) within a range between −thr5 and positive thr5. Threshold thr5 is based on a configured and stored quantization step size value associated with the image data 522. Deblocking filter module 516 determines a delta value according to equation (9), and determines a clamped delta value delta′ according to equation (10).

$$delta = ( 3 * ( s [ 0 ] j - s [ - 1 ] j ) - ( s [ 1 ] j - s [ - 2 ] j ) ) * 4 \qquad ( 9 )$$

$${delta}^{′} = clamp ( d , - h 5 , th 5 ) \qquad ( 10 )$$

In equation (9), j indicates a line of image data 522. While equation (9) involves a single line, the delta value and clamped delta value can also be determined using multiple lines (e.g., lines 0 and 3, or another set of lines) of the image data 522. In equation (10), the clamping function clamp( ) operates to clamp delta between −thr5 and thr5. For example, delta′=delta if delta is between −thr5 and thr5, delta′=−th5 if delta is less than or equal to −thr5, and delta′=th5 if delta is greater than or equal to thr5.

In some embodiments, the deblocking filter module 516 determines a symmetrical filter where N is the filter size or number of samples used for deblocking operations for each side of the boundary 602. In some embodiments, the deblocking filter module 516 determines an asymmetrical filter where N is the filter size or number of samples used for deblocking operations on a first side of the boundary 602, and the deblocking filter module 516 determines another value M for a second side of the boundary 602. M is determined in a manner similarly to N, however, the sample values are inverted. Notably, samples on both sides of the boundary 602 are used to determine each of N and M. By way of example, when determining M, equation (3) becomes d2[i]₀+d2[i]₃>thr1 for i=−1, 2. The deblocking filter module 516 also modifies and repeats equation (4)-(8) for the second side of the boundary 602.

For conditions with asymmetric length on two sides of the boundary 602, the deblocking filter module 516 performs deblocking, but does not use samples that are outside of the available length. For example, if samples 604 include all 9 columns, but samples 606 are limited to columns 0, 1, 2, and 3 an image edge, a tile edge, a superblock edge, or other region edge causes additional samples (e.g., columns 4, 5, 6, 7, and 8) to be nonexistent, unloaded into memory, or otherwise unavailable, then the nonexistent, unloaded, or unavailable samples are not used. In some embodiments, a number of samples that are available on at least one side of a block boundary is determined based on distance between a horizontal superblock boundary and the block boundary. In some embodiments, the deblocking filter module 516 determines whether an inequality requires or specifies unavailable samples, and omits evaluation of that inequality. In some embodiments, the deblocking filter module 516 uses a nominal value such as “0” or “1” as a stand in value for samples in order to evaluate an inequality that specifies unavailable samples. In some embodiments, when one or more samples on an upper or left side of a tile may be unavailable due to a limit on a line buffer, the deblocking filter module 516 tests one or more samples on at least one of a bottom or a right side of the tile to determine whether to apply filtering to an opposite side of the tile (or other region edge). By contrast, previous techniques do not provide for deblocking if a boundary 602 causes an asymmetrical number of samples, for example, if a number of samples between the boundary 602 and a region boundary is less than the maximum number of samples that is allowed for the technique.

The deblocking filter module 516 uses an iterative technique, such as a line-by-line and/or sample-by-sample (e.g., within each line) process, to modify samples s of the image data 522 into samples s′ of the modified image data 532. In some embodiments, the deblocking filter module 516 modifies samples 604 using equation (11), and separately modifies samples 606 using equation (12), thereby enabling asymmetrical sample modifications. In equation (11) and (12), i is a column identifier and j is a row identifier.

$${s}^{′} [ i ] j = s [ i ] j + {delta}^{′} * ( N - i ) / ( 2 * N + 1 ) , for i = 0 , … , N - 1 \qquad ( 11 )$$

$${s}^{′} [ - i - 1 ] j = s [ - i - 1 ] j + {delta}^{′} * ( M - i ) / ( 2 * M + 1 ) , \qquad ( 12 )$$

$$for i = 0 , … , M - 1$$

In some embodiments, the deblocking filter module 516 modifies samples of the image data 522 using an iterative technique such as a for loop, a while loop, or other loop command for each side of the boundary 602. The loop command increments an initial value to step through and perform a modification of each sample s of the image data 522 into a corresponding sample s′ of the modified image data 532.

In some embodiments, additionally or alternatively to equations (11) and (12), the deblocking filter module 516 determines a deblocked sample s′ by setting s′[i]=s[i] plus a value determined based on delta or delta′. In one example, delta′ is multiplied by N−i (or M−i) and s′ is determined by rounding a result of the multiplication to the nearest power of 2. For example, for a first side of the boundary 602, s[i]=s[i]+ROUND_POWER_OF_TWO(delta′*(N−i). In some embodiments, the result of (s[i]+ROUND_POWER_OF_TWO(delta′*(N−i)) is clipped or clamped within a configured range for sample values. For example, for a second side of the boundary 602, s[−i−1]=s[−i−1]+ROUND_POWER_OF_TWO(delta′*(M−i). In some embodiments, the result of (s[−i−1]+ROUND_POWER_OF_TWO(delta′*(M−i)) is clipped or clamped within a configured range for sample values.

### Determining Filter Lengths

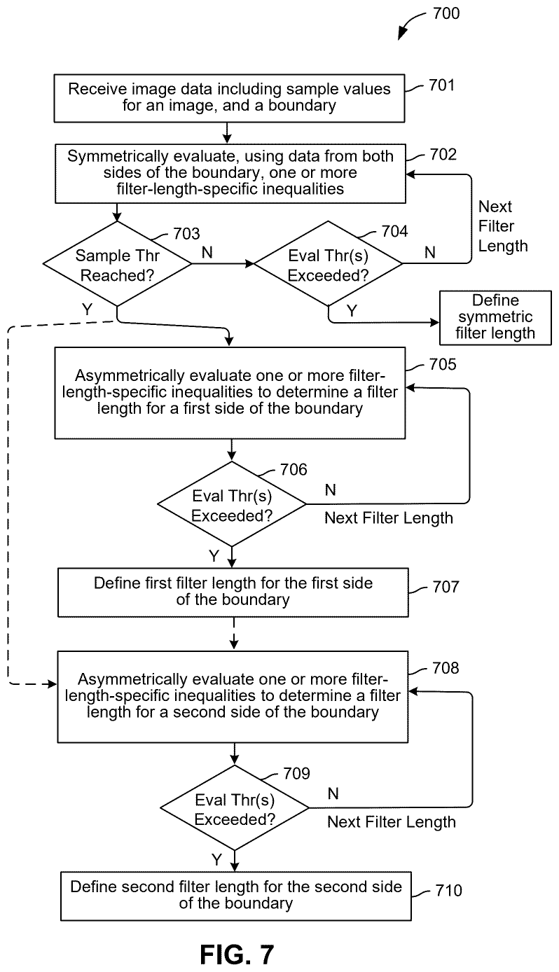

FIG. 7 sets forth a flow diagram of method steps for generating asymmetrical filter lengths relative to a block boundary, according to various embodiments. Although the method steps are described in conjunction with the systems of FIGS. 1-6, persons skilled in the art will understand that any system configured to perform the method steps in any order falls within the scope of the present disclosure. While the steps are indicated to be performed by the deblocking filter module 516, the steps can also be performed by or in conjunction with the filter sizing module 518.

As shown, a method 700 begins with step 701, where the deblocking filter module 516 receives image data 522 that includes sample values as well as a boundary 202. The image data 522 corresponds to any type of image, such as a still image, a frame of a video or animated image, and/or the like. In some embodiments, the image data 522 can include image data used by or generated during a decoding process in which encoded image data (e.g., encoded video frames) received from a content server 110 is decoded by the playback application 436. The method 700 can also be repeated for additional image data, such as other frames of a video.

At step 702, the deblocking filter module 516 symmetrically evaluates, using data from both sides of the boundary 202, one or more filter-length-specific inequalities. For example, the deblocking filter module 516 symmetrically evaluates inequalities using data for a symmetrical number of columns relative to the boundary 202. In some embodiments, the deblocking filter module 516 evaluates one or more of the inequalities (3)-(8), and potentially other inequalities. The inequalities (3)-(8) include values from two or more different lines of the image data 522. The deblocking filter module 516 makes a joint decision for multiple lines (e.g., four lines as discussed with respect to FIG. 6) of the image data 522 based on samples from two or more different lines. The filter length decision for the first side of boundary 202 is an iterative process that determines a first set of one or more one or more filter-length-specific inequalities for a first value of N, a second set of one or more one or more filter-length-specific inequalities for a second value of N, and so on.

At step 703, the deblocking filter module 516 determines whether a symmetrical evaluation sample threshold is reached. If the symmetrical evaluation sample threshold is reached, the method 700 proceeds to step 705 (and/or step 708) to perform an asymmetrical evaluation (e.g., using a different maximum number of columns on each side of boundary 202). Otherwise, method 700 proceeds to step 704.

At step 704, the deblocking filter module 516 determines whether one or more thresholds are exceeded based on the one or more filter-length-specific inequalities for the current or present filter length value N. If one or more of the thresholds are exceeded, the deblocking filter module 516 defines a symmetric filter length for both sides of the boundary 202. Otherwise, if the thresholds are not exceeded, then the deblocking filter module 516 increments the filter length value N and repeats step 702 with the next set of filter-length-specific inequalities.

At step 705, the deblocking filter module 516 asymmetrically evaluates one or more filter-length-specific inequalities to determine a filter length for a first side of boundary 202. In some embodiments, asymmetrical evaluation uses a different maximum number of columns on each side of boundary 202. In some embodiments, the deblocking filter module 516 evaluates one or more of the inequalities (3)-(8), and potentially other inequalities. The inequalities (3)-(8) include values from two or more different lines of the image data 522. In some embodiments, the deblocking filter module 516 modifies one or more of the inequalities (3)-(8), and potentially other inequalities, for example, to operate for the first side of boundary 202. In some embodiments one or more values (e.g., from the second side of boundary 202) used in the inequalities are unavailable and the corresponding evaluation is omitted. The deblocking filter module 516 makes a joint decision for multiple lines (e.g., four lines as discussed with respect to FIG. 6) of the image data 522 based on samples from two or more different lines. The filter length decision for the first side of boundary 202 is an iterative process that determines a first set of one or more one or more filter-length-specific inequalities for a first value of N, a second set of one or more one or more filter-length-specific inequalities for a second value of N, and so on.

At step 706, the deblocking filter module 516 determines whether one or more thresholds are exceeded based on the one or more filter-length-specific inequalities for the current or present filter length value N. If one or more of the thresholds are exceeded, the method 700 proceeds to step 707. Otherwise, if the thresholds are not exceeded, then the deblocking filter module 516 increments the filter length value N and repeats step 705 with the next set of filter-length-specific inequalities.

At step 707, the deblocking filter module 516 defines a first filter length N for the first side of the boundary 202. In some embodiments, the deblocking filter module 516 defines the first filter length N as the final value for N for which the thresholds are not exceeded. If the first value for N causes one or more thresholds to be exceeded, the first value for N is used, as there is no prior N value for which thresholds are not exceeded. Alternatively, in some embodiments, the deblocking filter module 516 defines the first filter length N as the first value for N for which the thresholds are exceeded. In some embodiments, such as where the symmetrical evaluation sample threshold is based on a limited number of available samples on one side of the block boundary, the deblocking filter module 516 defines the filter length for the second side of the boundary 202 to be equivalent to the symmetrical evaluation sample threshold, and steps 708-710 are omitted.

At step 708, the deblocking filter module 516 asymmetrically evaluates one or more filter-length-specific inequalities to determine a filter length for a second side of boundary 202. In some embodiments, the deblocking filter module 516 modifies one or more of the inequalities (3)-(8), and potentially other inequalities, for example, to operate for the second side of the boundary 202. The resulting inequalities include values from two or more different lines of the image data 522. In some embodiments, one or more of steps 708-710 are performed in parallel and/or with at least partial concurrence relative to steps 705-707.

At step 709, the deblocking filter module 516 determines whether one or more thresholds are exceeded based on the one or more filter-length-specific inequalities for the current or present filter length value M. If one or more of the thresholds are exceeded, the method 700 proceeds to step 710. Otherwise, if the thresholds are not exceeded, then the deblocking filter module 516 increments the filter length value M and repeats step 708 with the next set of filter-length-specific inequalities.

At step 710, the deblocking filter module 516 defines the first filter length M for the second side of the boundary 202. In some embodiments, deblocking filter module 516 defines the second filter length M as the final value for M for which the thresholds are not exceeded. If the first value for M causes one or more thresholds to be exceeded, the first value for M is used, as there is no prior M value for which thresholds are not exceeded. Alternatively, the deblocking filter module 516 defines the first filter length M as the first value for M for which the thresholds are exceeded.

### Deblocking Filtering

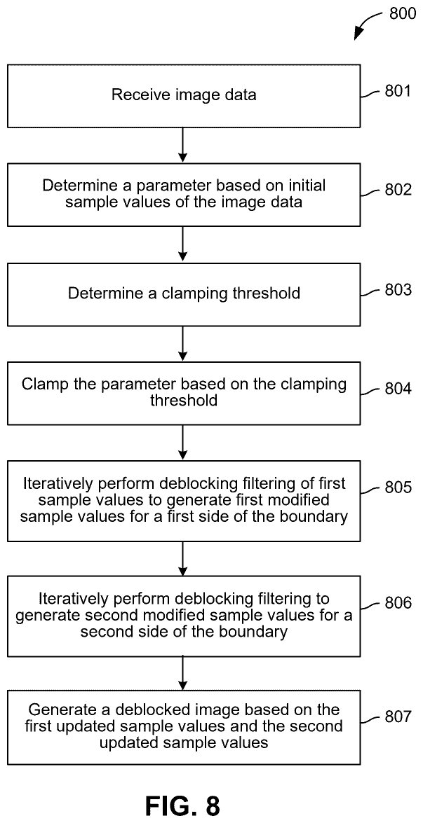

FIG. 8 sets forth a flow diagram of method steps for deblocking filtering, according to various embodiments. Although the method steps are described in conjunction with the systems of FIGS. 1-6, persons skilled in the art will understand that any system configured to perform the method steps in any order falls within the scope of the present disclosure. While the steps are indicated to be performed by the deblocking filter module 516, the steps can also be performed by or in conjunction with the sample modification module 519.

As shown, a method 800 begins with step 801, where the deblocking filter module 516 receives image data 522. The image data 522 corresponds to any type of image, such as a still image, a frame of a video or animated image, and/or the like. In some embodiments, the image data 522 can include image data used by or generated during a decoding process in which encoded image data (e.g., encoded video frames) received from a content server 110 is decoded by the playback application 436. The method 800 can also be repeated for additional image data, such as other frames of a video.

At step 802, the deblocking filter module 516 determines a first parameter based on initial sample values of image data 522. For example, in some embodiments, the deblocking filter module 516 determines a delta value according to equation (9). While equation (9) involves a single line, the delta value and clamped delta value can also be determined using multiple lines (e.g., lines 0 and 3, or another set of lines) of the image data 522.

At step 803, the deblocking filter module 516 determines a clamping threshold or range. In some embodiments, the clamping threshold is a configurable range stored and/or retrieved from a datastore. Additionally or alternatively, the clamping threshold or range is based on a width of a largest one of a first filter length and a second filter length. In some embodiments, the first and second filter lengths are determined as described with respect to the method 700 of FIG. 7. In some embodiments, the clamping threshold is a multiple of the width of a largest one of a first filter length N and a second filter length M. In some embodiments, the multiple is determined based on a quantization step size associated with the image data 522.

At step 804, the deblocking filter module 516 clamps the first parameter based on the clamping threshold or range. In some embodiments, the first parameter is delta, and a clamped version of the first parameter is delta′.

At step 805, the deblocking filter module 516 iteratively performs deblocking filtering on first sample values 604 to generate first modified sample values 608 for a first side of a boundary 602. The deblocking filter module 516 uses an iterative technique such as a line-by-line and/or sample-by-sample (e.g., within each line) process to modify samples s of the first sample values 604 into samples s′ of the modified sample values 608. In some embodiments, a number of iterations for each line matches a first filter length N.

At step 806, the deblocking filter module 516 iteratively performs deblocking filtering on second sample values 606 to generate second modified sample values 610 for a first side of a boundary 602. The deblocking filter module 516 uses an iterative technique such as a line-by-line and/or sample-by-sample (e.g., within each line) process to modify samples s of the second sample values 606 into samples s′ of the modified sample values 610. In some embodiments, a number of iterations for each line matches a second filter length M.

At step 807, the deblocking filter module 516 generates a deblocked image based on the first modified sample values 608 and the second modified sample values 610. In some embodiments, the playback application 436 causes the deblocked image to be displayed, such as via the display device 450. In some embodiments, the playback application 436 can further process the deblocked image before displaying the processed results.

In sum, techniques are disclosed for improved deblocking filtering. In some embodiments, a deblocking filter module of a playback application receives a first block and a second block of a first image. The deblocking filter module performs, based on sample values on one or more sides of a block boundary between the first block and the second block, one or more evaluations of inequalities relative to one or more thresholds, where the sample values include values for two or more of a plurality of lines of the first image. The deblocking filter module determines, based on the one or more evaluations, a first number of samples to modify on a first side of a block boundary between the first block and the second block, where the first number is different from a second number of samples to modify on a second side of the block boundary. In addition, the deblocking filter module performs, based on the first number of samples and the second number of samples, asymmetrical deblocking filtering on the first image to generate a second image.

At least one technical advantage of the disclosed techniques relative to the prior art is that the disclosed techniques enable deblocking operations in scenarios where samples are unavailable, for example, based on coding tree unit boundaries and/or tile boundaries. An additional technical advantage of the disclosed techniques is that the number of samples on each side of a block boundary is determined independently, enabling asymmetrical numbers of samples on each side of the block boundary. Another technical advantage of the disclosed techniques is that the number of samples on each side of a block boundary is dynamically determined multiple times per image to optimize deblocking performance in multiple regions of the image. A further technical advantage is multiple different lines (or columns) can be used to determine the number of samples on each side of a block boundary. Accordingly, the disclosed techniques can improve the quality of decoded video frames, including reducing or eliminating artifacts therein, relative to conventional deblocking filtering. These technical advantages provide one or more technological improvements over prior art approaches.
1. In some embodiments, a computer-implemented method for deblocking filtering, the method comprising receiving a first block and a second block of a first image, performing, based on sample values on one or more sides of a block boundary between the first block and the second block, one or more evaluations relative to one or more thresholds, wherein the one or more evaluations comprise two or more second derivatives for two or more lines of the first image, determining, based on the one or more evaluations, a first number of samples to modify on a first side of the block boundary, wherein the first number is different from a second number of samples to modify on a second side of the block boundary, and performing, based on the first number of samples and the second number of samples, asymmetrical deblocking filtering on the first image to generate a second image.
2. The computer-implemented method of clause 1, wherein the steps further comprise causing the second image to be displayed via a display device.
3. The computer-implemented method of clauses 1 or 2, wherein the deblocking filtering is further based on a maximum length of one or more luma samples.
4. The computer-implemented method of any of clauses 1-3, wherein the deblocking filtering is further based on a maximum length of one or more samples at a bottom side of a horizontal boundary of a tile and at a right side of a vertical tile boundary of the tile.
5. The computer-implemented method of any of clauses 1-4, wherein the sample values used for the one or more evaluations include values for two or more of a plurality of lines of the first image, and the first number of samples to modify on the first side of the block boundary is a joint filtering decision for the plurality of lines.
6. The computer-implemented method of any of clauses 1-5, wherein at least one of the first number of samples or the second number of samples is determined based on a distance between the block boundary and a superblock boundary.
7. The computer-implemented method of any of clauses 1-6, wherein the deblocking filtering does not use one or more samples outside a predefined length for conditions with asymmetric length on two sides of the block boundary.
8. The computer-implemented method of any of clauses 1-7, wherein the deblocking filtering comprises, when one or more samples on an upper or left side of a tile are unavailable due to a limit on a line buffer, testing one or more samples on at least one of a bottom or a right side of the tile to determine whether to apply filtering to an opposite side of the tile.
9. The computer-implemented method of any of clauses 1-8, and the second number of samples is a second filter length for the asymmetrical deblocking filtering for a second side of the block boundary.
10. The computer-implemented method of any of clauses 1-9, wherein the steps further comprise transmitting the second image over a network.
11.In some embodiments, one or more non-transitory computer-readable media store instructions that, when executed by one or more processors, cause the one or more processors to perform the steps of receiving a first set of samples and a second set of samples of a first image, performing, based on sample values on one or more sides of a block boundary between the first set of samples the second set of samples, one or more evaluations relative to one or more thresholds, wherein the one or more evaluations comprise two or more second derivatives for two or more lines of the first image, determining, based on the one or more evaluations, a first number of samples to modify on a first side of the block boundary, wherein the first number is different from a second number of samples to modify on a second side of the block boundary, and performing, based on the first number of samples and the second number of samples, asymmetrical deblocking filtering on the first image to generate a second image.
12. The one or more non-transitory computer-readable media of clause 11, wherein the deblocking filtering is further based on a maximum length of one or more chroma samples.
13. The one or more non-transitory computer-readable media of clauses 11 or
12, wherein the steps further comprise determining a parameter based on one or more of the first set of samples and the second set of samples, and clamping the parameter within a configurable range for the parameter, wherein the parameter is used to modify samples of the first image to generate the samples of the second image.
14. The one or more non-transitory computer-readable media of any of clauses 11-13, wherein the sample values used for the one or more evaluations include values for two or more of a plurality of lines of the first image, and the first number of samples to modify on the first side of the block boundary is a joint filtering decision for the plurality of lines.
15. The one or more non-transitory computer-readable media of any of clauses 11-14, wherein the asymmetrical deblocking filtering includes iteratively modifying a first set of sample values on a first side of the block boundary for a first number of iterations based on the first number of samples, and iteratively modifying a second set of sample values on a second side of the block boundary for a second number of iterations based on the second number of samples.
16. The one or more non-transitory computer-readable media of any of clauses 11-15, wherein the steps further comprise causing the second image to be displayed via a display device.
17. The one or more non-transitory computer-readable media of any of clauses 11-16, wherein the second image is a deblocked version of the first image.
18. The one or more non-transitory computer-readable media of any of clauses 11-17, wherein the first number of samples is a first filter length for the asymmetrical deblocking filtering for a first side of the block boundary, and the second number of samples is a second filter length for the asymmetrical deblocking filtering for a second side of the block boundary.
19. The one or more non-transitory computer-readable media of any of clauses 11-18, wherein at least one of the first number of samples or the second number of samples is determined based on a distance between the block boundary and a superblock boundary.
20.In some embodiments, a system comprises one or more memories storing instructions, and one or more processors that are coupled to the one or more memories and, when executing the instructions, are configured to receive a first set of samples and a second set of samples of a first image, perform, based on sample values on one or more sides of a block boundary between the first set of samples the second set of samples, one or more evaluations relative to one or more thresholds, wherein the one or more evaluations comprise two or more second derivatives for two or more lines of the first image, determine, based on the one or more evaluations, a first number of samples to modify on a first side of the block boundary, wherein the first number is different from a second number of samples to modify on a second side of the block boundary, and perform, based on the first number of samples and the second number of samples, asymmetrical deblocking filtering on the first image to generate a second image.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may include a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for deblocking filtering, the method comprising:
receiving a first block and a second block of a first image;
performing, based on sample values on one or more sides of a block boundary between the first block and the second block, one or more evaluations relative to one or more thresholds, wherein the one or more evaluations comprise two or more second derivatives for two or more lines of the first image;
determining, based on the one or more evaluations, a first number of samples to modify on a first side of the block boundary, wherein the first number is different from a second number of samples to modify on a second side of the block boundary; and
performing, based on the first number of samples and the second number of samples, asymmetrical deblocking filtering on the first image to generate a second image.

2. The computer-implemented method of claim 1, wherein the steps further comprise causing the second image to be displayed via a display device.

3. The computer-implemented method of claim 1, wherein the deblocking filtering is further based on a maximum length of one or more luma samples.

4. The computer-implemented method of claim 1, wherein the deblocking filtering is further based on a maximum length of one or more samples at a bottom side of a horizontal boundary of a tile and at a right side of a vertical tile boundary of the tile.

5. The computer-implemented method of claim 1, wherein the sample values used for the one or more evaluations include values for two or more of a plurality of lines of the first image, and the first number of samples to modify on the first side of the block boundary is a joint filtering decision for the plurality of lines.

6. The computer-implemented method of claim 1, wherein at least one of the first number of samples or the second number of samples is determined based on a distance between the block boundary and a superblock boundary.

7. The computer-implemented method of claim 1, wherein the deblocking filtering does not use one or more samples outside a predefined length for conditions with asymmetric length on two sides of the block boundary.

8. The computer-implemented method of claim 1, wherein the deblocking filtering comprises, when one or more samples on an upper or left side of a tile are unavailable due to a limit on a line buffer, testing one or more samples on at least one of a bottom or a right side of the tile to determine whether to apply filtering to an opposite side of the tile.

9. The computer-implemented method of claim 1, wherein the first number of samples is a first filter length for the asymmetrical deblocking filtering for a first side of the block boundary, and the second number of samples is a second filter length for the asymmetrical deblocking filtering for a second side of the block boundary.

10. The computer-implemented method of claim 1, wherein the steps further comprise transmitting the second image over a network.

11. One or more non-transitory computer-readable media storing instructions that, when executed by one or more processors, cause the one or more processors to perform the steps of:
receiving a first set of samples and a second set of samples of a first image;
performing, based on sample values on one or more sides of a block boundary between the first set of samples the second set of samples, one or more evaluations relative to one or more thresholds, wherein the one or more evaluations comprise two or more second derivatives for two or more lines of the first image;
determining, based on the one or more evaluations, a first number of samples to modify on a first side of the block boundary, wherein the first number is different from a second number of samples to modify on a second side of the block boundary; and
performing, based on the first number of samples and the second number of samples, asymmetrical deblocking filtering on the first image to generate a second image.

12. The one or more non-transitory computer-readable media of claim 11, wherein the deblocking filtering is further based on a maximum length of one or more chroma samples.

13. The one or more non-transitory computer-readable media of claim 11, wherein the steps further comprise:
determining a parameter based on one or more of the first set of samples and the second set of samples; and
clamping the parameter within a configurable range for the parameter, wherein the parameter is used to modify samples of the first image to generate the samples of the second image.

14. The one or more non-transitory computer-readable media of claim 11, wherein the sample values used for the one or more evaluations include values for two or more of a plurality of lines of the first image, and the first number of samples to modify on the first side of the block boundary is a joint filtering decision for the plurality of lines.

15. The one or more non-transitory computer-readable media of claim 11, wherein the asymmetrical deblocking filtering includes iteratively modifying a first set of sample values on a first side of the block boundary for a first number of iterations based on the first number of samples, and iteratively modifying a second set of sample values on a second side of the block boundary for a second number of iterations based on the second number of samples.

16. The one or more non-transitory computer-readable media of claim 11, wherein the steps further comprise causing the second image to be displayed via a display device.

17. The one or more non-transitory computer-readable media of claim 11, wherein the second image is a deblocked version of the first image.

18. The one or more non-transitory computer-readable media of claim 11, wherein the first number of samples is a first filter length for the asymmetrical deblocking filtering for a first side of the block boundary, and the second number of samples is a second filter length for the asymmetrical deblocking filtering for a second side of the block boundary.

19. The one or more non-transitory computer-readable media of claim 11, wherein at least one of the first number of samples or the second number of samples is determined based on a distance between the block boundary and a superblock boundary.

20. A system, comprising:
one or more memories storing instructions; and
one or more processors that are coupled to the one or more memories and, when executing the instructions, are configured to:
receive a first set of samples and a second set of samples of a first image;
perform, based on sample values on one or more sides of a block boundary between the first set of samples the second set of samples, one or more evaluations relative to one or more thresholds, wherein the one or more evaluations comprise two or more second derivatives for two or more lines of the first image;
determine, based on the one or more evaluations, a first number of samples to modify on a first side of the block boundary, wherein the first number is different from a second number of samples to modify on a second side of the block boundary; and
perform, based on the first number of samples and the second number of samples, asymmetrical deblocking filtering on the first image to generate a second image.
